(19) United States
(12) Patent Application Publication
(10) Pub. No.: US 2006/0234388 A1
(43) Pub. Date: Oct. 19, 2006

(54) Spectrophotometric Measurements of pH in-situ

(75) Inventors: Robert H. Bryne, St. Petersburg, FL (US); Eric Kaltenbacher, St. Petersburg, FL (US); Xuewu Liu, St. Petersburg, FL (US)

Correspondence Address: SMITH HOPEN, PA, 180 PINE AVENUE NORTH, OLDSMAR, FL, 34677, US

(73) Assignee: University of South Florida, Tampa, FL (US)

(21) Appl. No.: 11/279,437

(22) Filed: Apr. 12, 2006

Related U.S. Application Data
(60) Provisional application No. 60/670,408, filed on Apr. 12, 2005.

(51) Int. Cl. G01N 21/64

(52) U.S. Cl. 436/163; 436/171

(57) ABSTRACT

Automated in-situ instrumentation has been developed for sensitive, precise and accurate measurements of a variety of analytes in natural waters. In this work we describe the use of ‘SEAS’ (Spectrophotometric Elemental Analysis System) instrumentation for measurements of solution pH. SEAS-pH incorporates a CCD-based spectrophotometer, an incandescent light source, and dual pumps for mixing natural water samples with a sulfonephthalein indicator. The SEAS-pH optical cell consists of either a liquid core waveguide (LCW, Teflon AF 2400) or custom-made PEEK tubing. Long optical pathlengths allow use of indicators at low concentrations, thereby precluding indicator-induced pH perturbations. Laboratory experiments show that pH measurements obtained using LCW and PEEK optical cells are indistinguishable from measurements obtained using conventional spectrophotometric cells and high-performance spectrophotometers. Deployments in the Equatorial Pacific and the Gulf of Mexico demonstrate that the SEAS-pH instrument is capable of obtaining vertical pH profiles with high spatial resolution. SEAS-pH deployments at a fixed river-site (Hillsborough River, Fla.) demonstrate the capability of SEAS for observations of diel pH cycles with high temporal resolution. The in-situ precision of SEAS-pH is better than 0.002 pH units, and the system's measurement frequency is approximately 0.5 Hz. This work indicates that in-situ instrumentation can be used to provide unique capabilities for observations of carbon-system transformations in the natural environment.

### CROSS REFERENCE TO RELATED APLICATIONS

This application claims priority to currently pending U.S. Provisional Patent Application 60/670,408, entitled, “pH Sensor”, filed Apr. 12, 2005.

### STATEMENT OF GOVERNMENT INTEREST

This invention was made with Government support under Grant No. N00014-96-1-5011 awarded by the Office of Naval Research and Grant No. NA040AR4310096 awarded by the National Oceanic and Atmospheric Administration. The Government has certain rights in the invention.

### FIELD OF INVENTION

This invention relates to a pH measuring devices. More particularly, this invention relates to in-situ spectrophotometric pH measurement in natural water.

### BACKGROUND OF INVENTION

Solution pH is widely conceptualized as a master variable in the regulation of natural aqueous systems. It is a key feature in descriptive models of carbonate system chemistry, trace metal speciation and bioavailability, oxidation-reduction equilibria and kinetics, biologically induced carbon system transformations, and the aqueous interactions and transformations of minerals. Paleo-pH reconstructions via observations of boron isotope ratios in marine carbonates are currently being pursued as a key to modeling the CO₂ levels of paleo-atmospheres. The importance of pH in investigations of terrestrial and oceanic biogeochemistry has necessitated improvements in not only the quality of measurements (precision and accuracy), but also the spatial and temporal resolution of measurements in the field.

Both potentiometric and spectrophotometric procedures are widely utilized for pH measurements. The relatively simple equipment and procedures required for potentiometric pH measurements make potentiometry a good choice for field measurements as long as there are not stringent requirements for accuracy and precision. Under ideal conditions, potentiometric measurements that utilize glass hydrogen ion selective electrodes can provide measurement precisions on the order of 0.003 pH units (12). However, measurement accuracy is somewhat more problematic. Potentiometric measurements require regular buffer calibrations, and special care must be taken to address artifacts associated with both residual liquid junction potentials and variations in asymmetry potentials. In a recent evaluation that compared the performance of six electrodes under identical operational conditions, Seiter and DeGrandpre observed that individual electrodes generally have distinctive drift patterns, with drift rates up to 0.02 pH units per day (Seiter, J. C.; DeGrandpre, M. D. Talanta 2001, 54, 99). Electrode drift necessitates frequent calibrations, making autonomous operation somewhat problematic compared to spectrophotometric pH determinations.

Although potentiometric pH measurements are versatile and satisfactory for many applications, spectrophotometric pH measurement procedures have at least two important advantages that make them particularly desirable. Since spectrophotometric pH measurements can be determined via absorbance ratios, and the calibration of pH indicators is a laboratory exercise that establishes how each indicator's molecular properties vary with temperature, pressure and ionic strength, spectrophotometric pH measurements are inherently calibrated and can be termed “calibration free”. Subsequent to careful laboratory calibration, spectrophotometric pH measurements do not require the use of buffers. Secondly, thousands of at-sea observations have demonstrated that the imprecision of shipboard spectrophotometric pH measurements is on the order of 0.0003 to 0.0004 pH units, approximately an order of magnitude better than potentiometric results. These advantageous attributes of spectrophotometric pH measurements have made spectrophotometric procedures valuable for not only observations of pH, but also for measurements of CO₂ fugacity and total dissolved inorganic carbon.

Spectrophotometric pH measurements have been increasingly utilized for measurements of pH in natural waters. Bellerby et al. developed a flow injection procedure for spectrophotometric measurement of seawater pH with a reported precision of 0.005 pH units and a sample frequency of 25 hr⁻¹(Bellerby R. G. J.; Turner, D. R.; Millward, G. E.; Worsfold P. J. Analytica Chimica Acta 1995, 309, 259.). Tapp et al. described the use of a shipboard system for spectrophotometric measurements of surface water pH with a reported precision on the order of 0.001 pH units and a 1-Hz measurement frequency (Tapp, M.; Hunter, K.; Currie, K.; Mackaskill, B. Mar. Chem. 2000, 72, 193.). Relative to discrete measurements however, observed discrepancies were as large as 0.02 pH units. Martz et al. described the construction of a submersible pH sensor with a 0.003 unit measurement precision and a measurement frequency of 6 hr⁻¹ (Martz, T. R.; Carr, J. J.; French, C. R.; DeGrandpre, M. D. Anal. Chem. 2003, 75, 1844.).

SUMMARY OF INVENTION

The present invention provides an automated in-situ instrumention and associated methodologies for the sensitive, precise and accurate measurement of solution pH for a variety of analytes such as natural waters. In certain embodiments the system employs a spectrophotometer, an incandescent light source, and dual pumps for mixing natural water samples with a sulfonephthalein indicator. The can include a liquid core waveguide (LCW, Teflon AF 2400) or custom-made PEEK tubing. Long optical pathlengths allow use of indicators at low concentrations, thereby precluding indicator-induced pH perturbations.

The present invention further provides a method for the spectrophotometric measurement of the pH of a sample liquid. In an advantageous embodiment the method includes the steps of introducing a sample liquid including a pH indicator into the interior of a Teflon AF liquid core waveguide, measuring the absorbance ratio of the sample liquid at a plurality of wavelengths using the liquid core waveguide and calculating the pH of the sample liquid from the measured absorbance ratios. In certain advantageous embodiments the Teflon AF liquid core waveguide is a Teflon AF-2400 liquid core waveguide. The pH indicator can be a sulfonephthalein indicator such as cresol purple or thymol. The pH indicator can include one or more anionic surfactants. Advantageous anionic surfactants include lauryl sulfate and alkyldiphenyloxide disulfonate surfactant.

In an alternative embodiment the method includes the steps of introducing a sample liquid including a pH indicator into the interior of a polyetheretherketone (PEEK) optical cell, measuring the absorbance ratio of the sample liquid at a plurality of wavelengths using the liquid core waveguide and calculating the pH of the sample liquid from the measured absorbance ratios. The pH indicator can be a sulfonephthalein indicator such as cresol purple or thymol.

### BRIEF DESCRIPTION OF THE DRAWINGS

For a fuller understanding of the invention, reference should be made to the following detailed description, taken in connection with the accompanying drawings, in which:

FIG. 1 is a schematic representation of the SEAS instrument. Elements of the instrument include: a pressure vessel with control electronics, spectrometer and light source, two peristaltic pumps, optical cell (LCW, or PEEK), couplers to introduce light and solution to the optical cell and a reservoir for pH indicator. The block arrows indicate direction of fluid flow as pH indicator is combined with seawater, pumped through the optical cell, and finally discharged. Spectral data are sent from the spectrometer to the control electronics for real-time calculations and storage. An external connector provides an interface to a battery and CTD.

FIG. 2 shows a comparison of R values obtained using LCW and PEEK optical cells with R values obtained using conventional instruments and standard 10 cm optical cell. Solid lines indicate linear best fit of the data. All fitting errors are expressed in terms of 95% confidence intervals. Total boron concentration ([B(OH)₃]+[B(OH)₄⁻]) equals 0.04 m. Thymol blue concentration is 2 μM: (a) R(LCW) vs. R (Conventional cell) in synthetic seawater at 25° C.; (b) R(LCW) vs. R (Conventional cell) in the presence of 0.001% Lauryl Sulfate in 0.7 m NaCl at 25° C.; (c) R(LCW) vs. R (Conventional cell) using synthetic seawater at different temperatures. The LCW was preconditioned with 1% Dowfax 2A1; (d) R(PEEK) vs. R (Conventional cell) using synthetic seawater at 25° C. The PEEK cell was not preconditioned with surfactant.

FIG. 3 shows contemporaneous pH measurements obtained by two SEAS instruments aboard NOAA Ship Ka'lmimoana at 140°W Equator. One instrument was equipped with an LCW optical cell and the other with a PEEK cell. The LCW cell was preconditioned with 1% Dowfax 2A1. Solid and broken lines represent linear best fits of the data from the PEEK and LCW cells, respectively.

FIG. 4 shows simultaneous pH measurements obtained using two SEAS instruments both equipped with PEEK cells (SEAS_a and SEAS_b) in the Gulf of Mexico: (a) Four SEAS-pH profiles are shown with their running average; (b) pH residuals relative to the running average for all depths sampled. Encircled data are shown on an expanded scale in FIG. 4(c); (c) pH residuals relative to the running average in the mixed layer (upper 50 m).

FIG. 5 shows diurnal pH and temperature changes in the Hillsborough River (Hillsborough River State Park, Fla.) on Feb. 15-16, 2005 ((a) and (b)) and Feb. 24-25, 2005 ((c) and (d)).

### DETAILED DESCRIPTION OF THE PREFERRED EMBODIMENT

Automated in-situ instrumentation has been developed for sensitive, precise and accurate measurements of a variety of analytes in natural waters. In this work we describe the use of ‘SEAS’ (Spectrophotometric Elemental Analysis System) instrumentation for measurements of solution pH. SEAS-pH incorporates a CCD-based spectrophotometer, an incandescent light source, and dual pumps for mixing natural water samples with a sulfonephthalein indicator. The SEAS-pH optical cell consists of either a liquid core waveguide (LCW, Teflon AF 2400) or custom-made PEEK tubing. Long optical pathlengths allow use of indicators at low concentrations, thereby precluding indicator-induced pH perturbations. Laboratory experiments show that pH measurements obtained using LCW and PEEK optical cells are indistinguishable from measurements obtained using conventional spectrophotometric cells and high-performance spectrophotometers. Deployments in the Equatorial Pacific and the Gulf of Mexico demonstrate that the SEAS-pH instrument is capable of obtaining vertical pH profiles with high spatial resolution. SEAS-pH deployments at a fixed river-site (Hillsborough River, Fla.) demonstrate the capability of SEAS for observations of diel pH cycles with high temporal resolution. The in-situ precision of SEAS-pH is better than 0.002 pH units, and the system's measurement frequency is approximately 0.5 Hz. This work indicates that in-situ instrumentation can be used to provide unique capabilities for observations of carbon-system transformations in the natural environment.

We describe the operation of a Spectrophotometric Elemental Analysis System (SEAS) for observations of in-situ pH. The system's performance has been evaluated over a number of important aspects: (1) The spectrophotometric performance of SEAS-pH is directly compared with observations obtained using conventional high performance spectrophotometers; (2) SEAS-pH performance is demonstrated by simultaneous deployments of SEAS systems in seawater over a 200 meter depth range; (3) The capability of SEAS-pH for measurements with high temporal resolution is demonstrated via observations of subtle diurnal pH variations in river water.

Spectrophotometric pH Measurement Principles

The quantitative principles of spectrophotometric pH measurements have been described in a variety of previous works (Byrne, R. H.; Breland, J. A. Deep-Sea Res. Part A 1989, 36, 803; Clayton, T. D.; Byrne. R. H. Deep-Sea Res. Part A 1993, 40, 2115; Zhang, H.; Byrne, R. H. Mar. Chem. 1996, 52, 17.). Measurements are based on observations of dissolved sulfonephthalein indicator absorbances. For optical pathlengths on the order of 10 cm or more, indicator concentrations can be kept sufficiently low such that pH perturbations from indicator additions are negligible. Within the natural pH range of seawater and freshwater investigated in this work, sulfonephthalein indicators (denoted as H2l) such as m-cresol purple and thymol blue exist in solution solely as HI- and fully dissociated I2-. These forms participate in the following equilibrium:
HI⁻=H⁺+I2⁻ (1)

Solution pH is determined from the relative concentrations of HI- and I2- via the following relationship:

$$pH = {pK}_{I} + log \frac{[ {I}^{2 -} ]}{[ {HI}^{-} ]} \qquad ( 2 )$$

where brackets ([])denote concentrations, K_{I} is the indicator dissociation constant

$$( {K}_{I} = \frac{[ {H}^{+} ] [ {I}^{2 -} ]}{[ {HI}^{-} ]} ) and {pK}_{I} = log {K}_{I} .$$

It has been shown that solution pH can be calculated from absorbance ratios (R =λ₂A/λ₁A, where λ₁ and λ₂ are wavelengths of absorbance maxima for HI⁻ and I²⁻) with the following equation:

$$pH = {pK}_{I} + log \frac{R - {e}_{1}}{{e}_{2} - {Re}_{3}} \qquad ( 3 )$$

The symbols e₁, e₂ and e₃ in Equation (3) refer to indicator molar absorbance ratios at wavelengths λ₁, and λ₂:

$${e}_{1} = \frac{{}_{{λ}_{2}}^{}{∈}{}_{HI}^{}}{{}_{{λ}_{1}}^{}{∈}{}_{HI}^{}} , {e}_{2} = \frac{{}_{{λ}_{2}}^{}{∈}{}_{I}^{}}{{}_{{λ}_{1}}^{}{∈}{}_{HI}^{}} , {e}_{3} = \frac{{}_{{λ}_{1}}^{}{∈}{}_{I}^{}}{{}_{{λ}_{1}}^{}{∈}{}_{HI}^{}} \qquad ( 4 )$$

where _{λ1}ε_{I} and _{λ2}ε_{I} are the molar absorption coefficients of I²⁻ at wavelengths λ₁ and λ₂, and _{λ1}ε_{HI} and _{λ2}ε_{HI} are the molar absorption coefficients of HI⁻ at wavelengths λ₁ and λ₂. In most cases, in the present study, thymol blue was used for seawater pH measurements. Absorption maxima of HI⁻ and I²⁻ for thymol blue occur at λ₁=435 nm and λ₂=596 nm, and the dependence of the thymol blue equilibrium constant (K_{I}) on temperature (T) and seawater salinity (S) is given as:

$${pK}_{I} = \frac{4.706 S}{T} + 26.3300 - 7.17218 log T - 0.017316 \qquad ( 5 )$$

Solution pH on the total hydrogen ion ([H⁺]_{T}) concentration scale is calculated from the equation

$${pH}_{T} = {pK}_{I} + log \frac{R - 0.0035}{2.3875 - 0.1387 R} \qquad ( 6 )$$

where pH_{T} is related to pH on the free hydrogen ion concentration scale (pH=−log[H⁺]) as follows:

$${pH}_{T} = - {log [ {H}^{+} ]}_{T} = - log [ {H}^{+} ] + log ( 1 + \frac{{S}_{T}}{{K}_{HSO 4}} ) \qquad ( 7 )$$

where S_{T} is the total sulfate concentration and K_{HSO4} is the H₂SO₄ dissociation constant.

When measurements are taken at pressures greater than 1 atmosphere, pK_{I} is calculated from the relationship:

$$log ( \frac{{K}_{I}^{P}}{{K}_{I}^{0}} ) = 2.99 ⨯ {10}^{- 4} P - 3.3 ⨯ {10}^{- 8} {P}^{2} \qquad ( 8 )$$

where K_{I}^{P} and K_{I}⁰ represent indicator dissociation constants at gauge pressure P and one atmospheric pressure (gauge pressure zero); In Equation (3), e₁=0.0035, e₂=2.386−2.7×10⁻⁶P and e₃=0.139+6.6×10⁻⁶P.

Using the above equations, in-situ spectrophotometric seawater pH measurements can be obtained throughout the oceanic water column. The pH values measured in this study all refer to in-situ temperatures and do not require further processing.

For river water, pH on the free hydrogen ion concentration scale can be quantified using phenol red or bromcresol purple indicators:

$$pH = {pK}_{I} + log \frac{R - {e}_{1}}{{e}_{2} - R {e}_{3}} - 4 A ( \frac{{μ}^{\frac{1}{2}}}{1 + {μ}^{\frac{1}{2}}} - 0.3 μ ) \qquad ( 9 )$$

where μ is the ionic strength, and
A=0.5115+(T−298.15)×8.57×10⁻⁴ (10)

The final term in Equation (9) accounts for the variation of I²⁻, HI⁻ and H⁺ activity coefficients with ionic strength using the Davies equation. We recommend use of this equation at low ionic strengths (μ≦0.02 M).

For phenol red (λ₁=433 nm, λ₂=558 nm), which has been used in the present work to measure river water pH, the following terms are used in Equation (9):

$${e}_{1} = 0.00244 , {e}_{2} = 2.734 and {e}_{3} = 0.1075 \\ and \\ {pK}_{I}^{0} ( phenol red ) = 5.798 + \frac{666.7}{T} \qquad ( 11 )$$

For the indicator bromcresol purple (λ₁=432 nm, λ₂=589 nm), the following terms may be similarly used as in Equation (9):

$${e}_{1} = 0.00387 , {e}_{2} = 2.858 and {e}_{3} = 0.0181 \\ and \\ {pK}_{1}^{0} ( bromcresol purple ) = 5.226 + \frac{378.1}{T} \qquad ( 12 )$$

SEAS Instrumental Characteristics

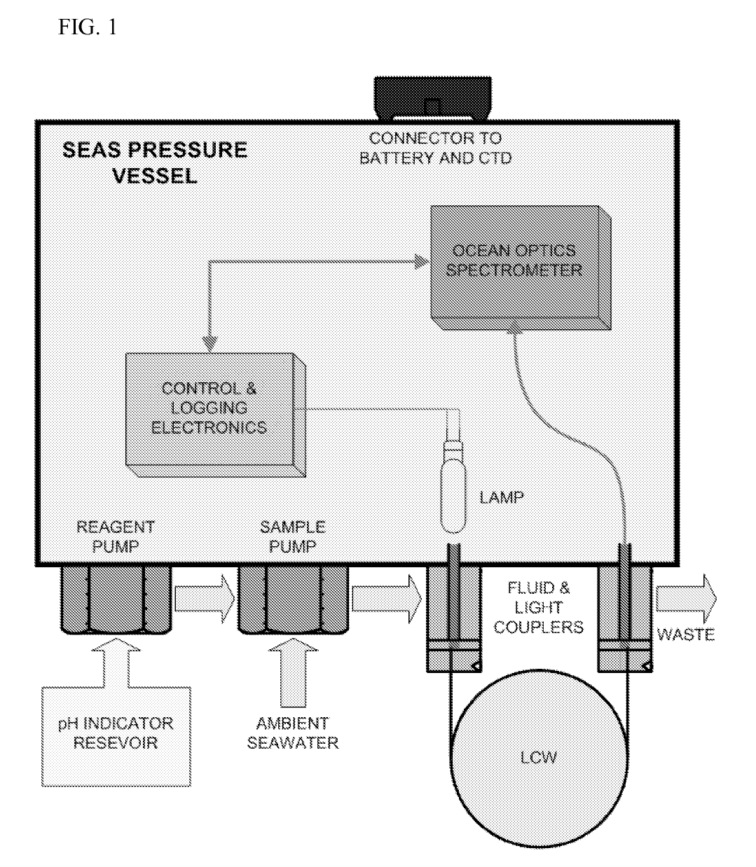

The SEAS instrument (FIG. 1) was developed at the Center for Ocean Technology, College of Marine Science, University of South Florida. SEAS electronics, spectrophotometer and lamp are enclosed within an anodized aluminum pressure housing. This housing can withstand pressures of at least 340 decibars while the sample and reagent pumps, as well as the optical cell, are exposed to ambient seawater. The instrument is 10 cm in diameter with a height of 50 cm. All operations of the instrument are microprocessor-controlled, and mission-parameters such as pumping rate and sampling mode are determined by the user. The instrument is capable of obtaining measurements with a sampling frequency on the order of 0.5 Hz.

The SEAS optical system utilizes an Ocean Optics S2000 CCD array spectrometer that is capable of spectral observations between 200 and 1100 nm. The system's optical cell consists of either a liquid core waveguide (LCW) constructed of Teflon AF-2400 (DuPont®) capillary tubing (˜0.8 mm o.d.×0.6 mm i.d.) (27) or custom machined PEEK tubing (˜2 mm i.d.). In either case, effective pathlengths are between 10 and 15 cm. Light from an incandescent lamp is transmitted to the optical cell via an optical fiber and a small coupling device that also allows introduction of solutions to the cell. After passing through the solution (liquid core) within the optical cell, light is transmitted through a second coupling device that also serves as a portal for fluid discharge. The transmitted light is collected by a second optical fiber that is connected to the CCD array spectrometer. The refractive index of Teflon AF-2400 (n_{T}˜1.29) is lower than the refractive index of seawater (n_{sw}=1.34), whereby light incident on the waveguide walls at angles greater than 74.3 degrees is confined within the liquid by total internal reflection. The light throughput of the small diameter PEEK optical cell used in this work is comparable to that of the LCW cell. Due to the small diameter of the optical cells, sample and reagent consumption is minimal.

Experiments

Measurements in Synthetic Solutions. The performance of SEAS instruments for measurements of pH was assessed via comparisons with measurements obtained using conventional high-performance spectrophotometers: an HP 8453 diode array spectrometer and a Cary 400 photodiode spectrometer. All laboratory tests were conducted at a constant temperature controlled to ±0.05° C. using Neslab RTE 221 or Lauda RE120 water circulators. Evaluations were obtained using well-buffered solutions of thymol blue in either synthetic seawater or NaCl solutions. All measurements with the HP 8453 and Cary 400 instruments were made with conventional 10 cm spectrophotometric cells. All measurements with SEAS instruments utilized either long-pathlength Teflon AF 2400 liquid core waveguides or custom-made long-pathlength PEEK cells.

Thymol blue stock solutions were prepared by dissolving the sodium salt of thymol blue (Sigma) in Milli-Q water to attain concentrations near 8 mM. The absorbance ratio (R) of this concentrated stock indicator solution was adjusted to approximately 0.8 via small additions of 1 M NaOH or HCl. To exclude atmospheric CO₂, indicator solutions were stored either in gas impermeable, laminated aluminum sample bags or glass syringes. Phenol red solutions were similarly prepared and the R ratio was adjusted to approximately 1.

Synthetic seawater solutions were composed using the recipe given in the Table 6.3 of (14), and NaCl solutions were prepared to be 0.7 molal. Excess borate/boric acid was added into both synthetic seawater and NaCl solutions for enhanced buffering, and the total boron concentration was 0.04 molal.

Oceanic pH Measurements.

SEAS-pH instruments were deployed in the Equatorial Pacific (0° 00.65 N, 139° 52.68 W) on the RN Ka' lmimoana and in the Gulf of Mexico (26° 49.4 N, 84° 45.0W) on the R/V Suncoaster. Deployed instrumentation included two SEAS, a CTD, and battery packs strapped to either a CTD-Rosette frame (Equatorial Pacific) or a custom-made aluminum alloy frame (Gulf of Mexico). SEAS instruments were programmed to collect pH and CTD data autonomously at a rate of approximately 0.5 Hz. Each pH measurement represented an average of 50 absorbance scans. After ten minutes allocated for the lamp to warm up, a peristaltic pump forced seawater through the SEAS optical cell and reference measurements were taken. While the sample pump continuously passed ambient seawater through the optical cell, the indicator pump was activated, injecting the indicator into the stream of seawater. Sample pH, depth, temperature and salinity were recorded as SEAS descended or ascended through the water column at five to six meters per minute. Maximum deployment depths were approximately 250 m.

Riverine pH Measurements.

The SEAS-pH instrument was deployed in February 2005 in the Hillsborough River State Park (28° 09′06″N and 82° 13′14″W) for periods in excess of 24 hours. The SEAS-pH instrument was configured with a PEEK cell, and was lowered one meter below the surface. A CTD was used to continuously record water temperature at the site. Instrumental parameter settings were identical to those used in oceanic deployments.

Results and Discussion

Laboratory SEAS-pH Performance.

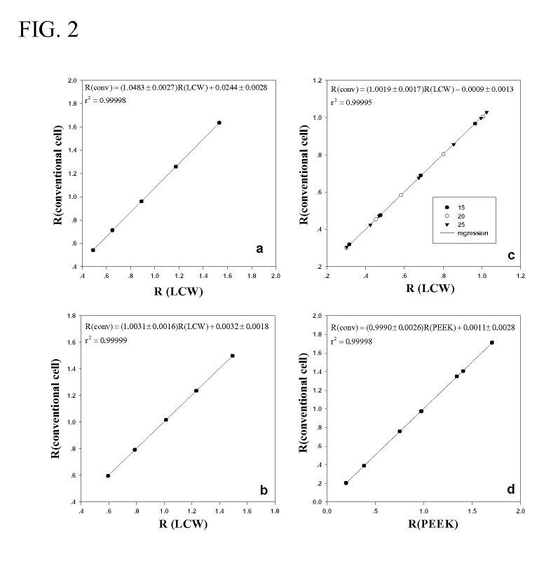

Comparisons between absorbance ratios (R) obtained using conventional 10 cm spectrophotometric cells in either Cary 400 or HP 8453 spectrophotometers, and absorbance ratios obtained using LCW optical cells initially showed poor agreement. R values obtained using conventional 10 cm optical cells (R(conventional cell)) plotted against R values obtained using LCW cells (R(LCW)) and the Ocean Optic spectrophotometers used in SEAS showed non-zero intercepts and slopes significantly greater than unity. As one example (FIG. 2a), for measurements obtained using thymol blue in synthetic seawater solutions buffered with borate/boric acid, it was observed that R(conventional cell)=(1.0483±0.0027)R(LCW)+0.0244±0.0028, where the listed uncertainties represent 95% confidence intervals. Although the linearity of such plots was typically excellent, the existence of non-zero intercepts, and slopes greater than unity, indicates that pH measurements obtained with LCWs do not exhibit the simplicity that is generally characteristic of spectrophotometric pH measurements. It was hypothesized that the observed problems were attributable to hydrophobicity of thymol blue whereupon indicator concentrations within the LCW were not homogeneous. Accordingly, the SEAS-pH measurement protocol was modified by adding an anionic surfactant to the indicator solution.

FIG. 2b shows the relationship between R(conventional cell) and R(LCW) obtained using a solution consisting of 2×10⁻⁶ M thymol blue plus 0.001% lauryl sulfate in 0.7 m NaCl. In the presence of this anionic surfactant, R values obtained using the LCW cell and conventional 10 cm cells were nearly indistinguishable (R(conventional cell)=(1.0031±0.0016)R(LCW) +0.0032±0.0018).

Measurements of pH in seawater require an alternative surfactant because lauryl sulfate precipitates in the presence of Ca²⁺ and Mg²⁺ at high concentrations. For measurements of seawater pH, the LCW was preconditioned with Dowfax 2A1 anionic aromatic surfactant, an alkylphenyloxide disulfonate surfactant. Subsequent to this pretreatment, R(conventional cell) and R(LCW) were in excellent agreement: (R(conventional cell)=(1.0019±0.0017)R(LCW)−0.0009±0.0013) (FIG. 2c). LCWs preconditioned in this manner were stable for more than one hour.

In contrast to the behavior of sulfonephthaleins in LCW cells, it was found that the sulfonephthalein behavior in custom-made PEEK optical cells and conventional spectrophotometric cells were essentially identical even in the absence of surfactants. FIG. 2d shows R(conventional cell) observations plotted against R(PEEK) data obtained in artificial seawater using a 15 cm pathlength PEEK cell. A linear regression of the FIG. 2d data, R(conventional cell)=(0.9990±0.0026) R(PEEK)+0.0011±0.0028) shows that, even in the absence of surfactants, SEAS instruments equipped with PEEK optical cells provide seawater pH measurements that are in excellent agreement with measurements obtained using conventional protocols. Consequently, although high quality in-situ pH measurements can be obtained using LCW cells with an appropriate surfactant, the most simple and therefore robust measurements will be obtained using PEEK cells.

SEAS-pH In-situ Performance

(1) Oceanic pH Measurements. Field deployments in the Equatorial Pacific compared contemporaneous SEAS pH observations obtained using an LCW optical cell and a PEEK cell. Deployments in the Gulf of Mexico compared contemporaneous measurements of two SEAS instruments both equipped with PEEK optical cells.

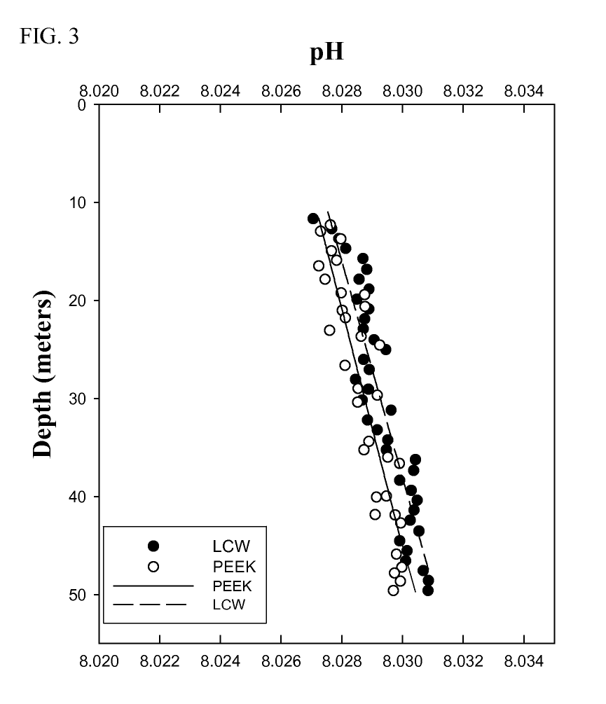

FIG. 3 shows pH observations (PEEK and LCW cells) within the mixed layer on Sep. 20, 2003 in the Equatorial Pacific. The two SEAS instruments deployed in tandem produced pH measurements that were in agreement within approximately 0.0009 pH units,
pH(LCW)=8.0267+9.070×10⁻⁵×(Depth/m), r²=0.838, and
pH(PEEK)=8.0262+8.226×10⁻⁵×(Depth/m), r²=0.801.

These observations (FIG. 3) constitute a strong demonstration that in-situ ratiometric pH measurements (i.e. Equations (5) and (6)) obtained using SEAS instruments are calibration-free.

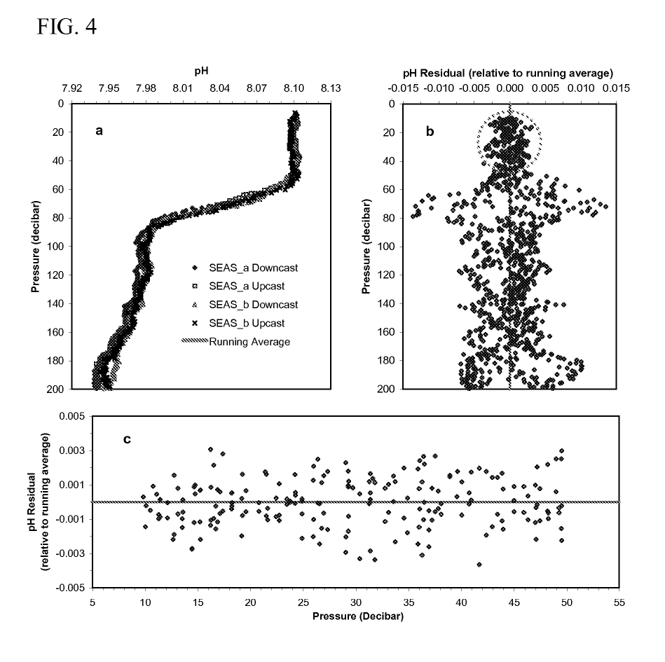

FIG. 4a shows contemporaneous pH observations (downcast and upcast) obtained on Mar. 25, 2004 using two SEAS instruments equipped with PEEK cells at a single station in the Gulf of Mexico. Downcast and upcast pH profiles from the two SEAS instruments are highly coherent. FIG. 4b shows residuals as a function of depth. These residuals depict deviations from the running average of all pH measurements (two instruments, upcasts and downcasts) vs. depth. Overall, the mean residual relative to the running average is 0.0001 pH with a standard deviation of 0.0039 pH (FIG. 4b). Relatively larger residuals are observed in the sharp pH gradient between 50 and 80 meters. In this depth range, small deviations in upcast and downcast depth estimates can contribute strongly to apparent discrepancies in pH. In contrast, in the upper 50 m where the water column is relatively well mixed, pH residuals were quite small (FIG. 4c). The water column in the upper 50 meters can be regarded as a single mixed solution. In this layer, repeated measurements produced a mean pH residual (relative to the FIG. 4a running average) equal to 0.0000 with a standard deviation equal to ±0.0014. FIG. 4 indicates that the precision of SEAS-pH field measurements is on the order of 0.0014 pH units. This is fully consistent with laboratory results. Taken together, FIGS. 3 and 4 show that pH measurements obtained using different instruments are consistent within approximately 0.001 pH units. Such differences are comparable to the current precision of the instruments.

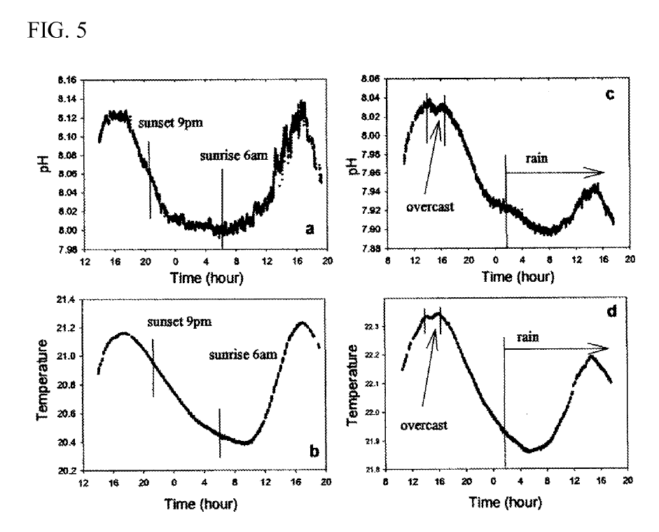

(2) Riverine pH measurements. FIG. 5 shows diurnal changes in the pH of the Hillsborough River obtained using a SEAS-pH instrument equipped with a PEEK cell (Feb. 15-16 and Feb.24 to 25, 2005). The February 15 to 16 data were collected on a clear day whereas the February 25 data were collected in rainy conditions. FIGS. 5a and 5c show that Hillsborough River pH undergoes diel cycles. Very similar cycles are shown for temperature (FIGS. 5b and 5d). FIGS. 5a and 5c show sharp increases in pH after sunrise and, in general, decreases after approximately 4 PM. Temperature shows a very similar pattern (FIGS. 5b and 5d). It is reasonable to presume that pH and water temperature are both responding to cycles of solar irradiation. Increased sunlight promotes increasing water temperature as well as photosynthesis which, in turn, will cause carbon fixation and increasing pH. FIGS. 5a and 5b show relatively symmetrical variations in pH and temperature for simple (clear sky) meteorological conditions. Under cloudy and rainy conditions (FIGS. 5c and 5d), pH and temperature variations are somewhat more complex. At approximately 2 PM, a brief period of overcast condition produced subtle but clearly resolved depressions in both pH and temperature (FIGS. 5c and 5d). This observation indicates that river water pH responds very rapidly to changes in light flux. Under the rainy conditions during February 25, the temperature increase (minimum to maximum) was ˜0.3° C. compared to a temperature increase of approximately 0.8° C. on February 16 under clear conditions. The corresponding pH changes on February 25 and 16 were approximately 0.04 and 0.12. It should be noted, in these cases, that within systems such as the Hillsborough River that are dominantly buffered by CO₃²⁻/HCO₃⁻, a 1° C. change in temperature would cause a change in in-situ pH on the order of only 0.014 pH units. Furthermore, increasing temperature would cause a decrease in pH. It is probable in these cases that changing water temperature is serving as a proxy for absorbed solar radiation. The curves shown in FIGS. 5a and 5c indicate that pH measurements with high temporal resolution can provide very useful perspectives on the carbon system dynamics of lakes and rivers.

General Perspectives on the Quality and Utility of in-situ pH Measurements

The quality of in-situ pH measurements can be usefully assessed in terms of the characteristics (e.g., accuracy and precision) of spectrophotometric measurements in the laboratory. Achievable accuracy and precision of spectrophotometric pH measurements have been assessed as ±0.001 and ±0.0004 (3, 28). Attainment of such accuracy and precision in the field requires the use of devices whose characteristics are comparable to those of instruments that have been used to measure sulfonephthalein physical/chemical properties in the laboratory (Byrne, R. H.; McElligott, S.; Feely, R. A.; Millero, F. J. Deep-Sea Res. Part I 1999, 46, 1985; Zhang, H.; Byrne, R. H. Mar. Chem. 1996, 52, 17; Clayton, T. D.; Byrne, R. H.; Breland, J. A.; Feely, R. A.; Millero, F. J.; Campbell, D. J.; Murry, P.; Bobert, M. L. Deep-Sea Res. Part A 1995, 42, 411.) In this work we have evaluated the performance of an in-situ spectrophotometric pH measurement system. Through laboratory measurements it was demonstrated that the optical system of SEAS provides absorbance ratio measurements that are concordant with those obtained using high quality laboratory spectrometers. As such, it should be expected that the accuracy of in-situ SEAS-pH measurements will be closely linked to the accuracy of measurements obtained by laboratory systems. SEAS-pH measurements in the field show excellent reproducibility between contemporaneously-deployed instruments, and measurement precisions on the order of 0.0014. Although this precision appears to be somewhat inferior to the precision of measurements obtained using conventional systems in the laboratory, it should be recognized that the high measurement frequency of SEAS (0.5 Hz) allows for considerable signal averaging. As such, the precision of running averages (spatial and temporal) is significantly improved relative to the precision of individual measurements.

Comparisons of conventional optical cells with small bore cells that are suitable for in-situ measurements indicate that the latter cells can exhibit nonlinear spectrophotometric behavior. This effect may be generated by interactions between sulfonephthaleins and the hydrophobic surface of Teflon AF 2400. The potential existence of such effects necessitates careful testing of narrow-bore optical cells for nonlinear behavior. The existence of nonlinear optical behavior would necessitate calibrations on a per instrument basis. In contrast, the present work shows that nonlinear behavior can be eliminated using either PEEK cells, or LCW cells treated with surfactants.

Field observations with SEAS-pH instruments demonstrate that pH measurements can be obtained with exceptionally high spatial and temporal resolution. In conjunction with profiling devices capable of slow descent and ascent through the water column (25), it is likely that spatial features such as phytoplankton thin layers (29) could be resolved on a vertical scale of 10 to 100 cm. The riverine observations obtained in this work indicate that pH and light levels are very tightly coupled with rapid response times. Taken together, our laboratory and field observations indicate that in-situ measurement capabilities are approaching the quality of laboratory measurements. Given the lability of pH during transport of water samples to the laboratory, such improvements are of critical importance to improved understanding of carbon system transformations in the environment.

While the invention has been described and exemplified in sufficient detail for those skilled in this art to make and use it, various alternatives, modifications, and improvements should be apparent without departing from the spirit and scope of the invention. The present invention is well adapted to carry out the objects and obtain the ends and advantages mentioned, as well as those inherent therein. The examples provided here are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

The disclosure of all publications cited above are expressly incorporated herein by reference, each in its entirety, to the same extent as if each were incorporated by reference individually.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A method for the spectrophotometric measurement of the pH of a sample liquid, the method comprising the steps of:
introducing a sample liquid including a pH indicator into the interior of a Teflon AF liquid core waveguide;
measuring the absorbance ratio of the sample liquid at a plurality of wavelengths using the liquid core waveguide; and
calculating the pH of the sample liquid from the measured absorbance ratios.

2. The method of claim 1 where the sample liquid is seawater and the pH is determined according to the equation:
$${pH}_{T} = {pK}_{I} + log \frac{R - 0.0035}{2.3875 - 0.1387 R} where$$
$${pK}_{I} = \frac{4.706 S}{T} + 26.3300 - 7.17218 log T - 0.017316 .$$

3. The method according to claim 1 wherein the Teflon AF liquid core waveguide is a Teflon AF-2400 liquid core waveguide.

4. The method according to claim 1 where the pH indicator comprises one or more anionic surfactants.

5. The method according to claim 3 where the anionic surfactant is selected from the group consisting of lauryl sulfate and alkyldiphenyloxide disulfonate surfactant.

6. The method of claim 1 where the pH indicator is a sulfonephthalein indicator.

7. The method of claim 1 where the pH indicator is selected from the group consisting of m-cresol purple and thymol blue.

8. A method for spectrophotometric measurement of the pH of a sample liquid, the method comprising the steps of:
introducing a sample liquid including a pH indicator into the interior of a polyetheretherketone (PEEK) optical cell;
measuring the absorbance ratio of the sample liquid at a plurality of wavelengths using the liquid core waveguide; and
calculating the pH of the sample liquid from the measured absorbance ratios.

9. The method of claim 7 where the pH indicator is a sulfonephthalein indicator.

10. The method of claim 7 where the pH indicator is selected from the group consisting of m-cresol purple and thymol blue.

11. The method of claim 7 where the sample liquid is seawater and the pH is determined according to the equation:
$${pH}_{T} = {pK}_{I} + log \frac{R - 0.0035}{2.3875 - 0.1387 R} where$$
$${pK}_{I} = \frac{4.706 S}{T} + 26.3300 - 7.17218 log T - 0.017316 .$$
